(19) United States
(12) Patent Application Publication
(10) Pub. No.: US 2006/0167115 A1
(43) Pub. Date: Jul. 27, 2006

(54) Compositions for the preservation of timber

(76) Inventors: Yossef Gohary, Meitar (IL); Haim Stollar, Omer (IL); Michal Levinger, Nofit (IL); Dikla Dvora, Beer Sheva (IL)

Correspondence Address: Kevin D McCarthy;Roach Brown MCarthy & Gruber, 1620 Liberty Bldg, Buffalo, NY, 14202, US

(21) Appl. No.: 10/541,143

(22) PCT Filed: Dec. 29, 2003
(86) PCT No.: PCT/IL03/01111

§ 371 Date: Jan. 30, 2006

(30) Foreign Application Priority Data
Jan. 6, 2003 (IL) 153811

(51) Int. Cl. A01N 31/08; B32B 21/02

(52) U.S. Cl. 514/735; 428/292.4

(57) ABSTRACT

The present invention provides antifungal compositions based on Tetrabromobisphenol A (TBBA), its homologues and derivatives, that can be used to preserve wood. The invention provide a method for the preservation of wood against fungal attack, that employs the impregnation of wood with TBBA or its homologues and derivatives.

### FIELD OF THE INVENTION

The present invention relates to the preservation of timber. More particularly, the invention relates to the use of tetrabromobisphenol A and homologues and derivatives thereof, as a timber preservative.

### BACKGROUND OF THE INVENTION

Timber in use and in storage is prone to deterioration by a variety of micro-organisms but especially fungi such as basidiomycetes and moulds. It is therefore common to use chemical preservative treatments to prevent such biological deterioration and there are many different wood preservatives known in the art. Wood is stored and used in a variety of forms, such as blocks, plates, planks, and poles. The terms “timber” and “wood” are used interchangeably herein to indicate all forms of wood in need of protection against biological attack.

Tetrabromobisphenol A (hereinafter referred to as “TBBA”) is a fire-retardant material widely employed in engineering plastics. It has been used in JP 61-6769 (Publication No. 55-159915, dated Dec. 12, 1980), to paint and coat a single plate which could then be preserved in the absence of mould growth. Although the antimicrobial activity of TBBA has been known for at least 20 years it has not yet found practical application in industry.

Fungal attack of wood generally results in loss of the structural strength elements (indicated by weight loss in laboratory tests) and ultimately leads to mechanical failure of the timber structure. When, for instance, wooden utility poles are erected in the ground, fungal attack will eventually cause the breakage of the pole near ground level. The art has provided a number of preservative types used to prolong pole service life (such as Creosote and Copper Chrome Arsenate). However, these preservative types display disadvantages such as high volatile organic compound (VOC) emissions (Creosote) and high heavy metal contents (CCA).

It is therefore an object of this invention to provide antifungal compositions based on TBBA, its homologues and derivatives, that can be used to preserve wood in the absence of the disadvantages inherent in other preserving compounds.

It is another purpose of this invention to provide a method for the preservation of wood against fungal attack, that employs the impregnation of wood with TBBA or its homologues and derivatives.

It is yet another purpose of the invention to provide a method and compositions that do not require the use of harmful solvents.

Other purposes and advantages of the invention will appear as the description proceeds.

### SUMMARY OF THE INVENTION

The present invention relates to a fungicidal wood preservative comprising active ingredients which are Tetrabromobisphenol A (TBBA) [CAS RN=79-94-7] or a homologue or a derivative thereof. TBBA is the tetrabrominated form of Bisphenol A of formula

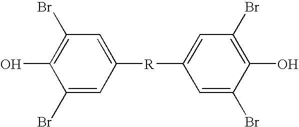

Where, for TBBA, R is C(CH₃)₂.

By “homologues” of TBBA it is meant to indicate those compounds in which the Bisphenol A bridge is replaced by a different moiety. Illustrative and non-limitative examples of such homologues include:
Tetrabromobisphenol F (TBBF), Bis(4-hydroxy-3,5-dibromophenyl)methane [CAS RN=21825-03-6], R is CH₂;
Tetrabromobisphenol Z (TBBZ), 4,4′-Cyclohexylidenebis(2,6-dibromophenol), [CAS RN=53350-96-2], R is 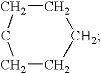
Tetrabromobisphenol E (TBBE), 4,4′-Ethylidenebis(2,6-dibromophenol), [CAS RN=126369-25-3], R is CHCH₃; and
Tetrabromobisphenol S (TBBS), 4,4′-Sulfonyldi(2,6-dibromophenol), [CAS RN=39635-79-5], R is SO₂.

By “derivatives” of TBBA it is meant to indicate those compounds that are further substituted by a substituent other than bromine, either on one or both phenyl rings, or at the bridge. Any such substitutions that do not substantially alter the wood-preserving activity of the resulting compound with respect to TBBA are also encompassed by the present invention.

Preferably, the compound employed is TBBA that has been solubilized in an organic or aqueous solvent. According to a preferred embodiment of the invention, the active compound is provided in aqueous solution. According to another preferred embodiment of the invention, the active compound is dissolved in an organic solvent such as alcohols, e.g. ethanol, hydrocarbons, toluene and ketones. According to a further preferred embodiment of the invention the active compound is incorporated in an emulsion.

The present invention permits long-term preservation of wood without mould growth and protection against wood-destroying Basidiomycete fungi. The long-term preservation of wood is achieved by impregnating it with an active ingredient, e.g., TBBA, a derivative or a homologue of TBBA, or a mixture of two or more of the same, in an aqueous or organic solution or in an emulsion.

A wood preservative comprising TBBA as the active ingredient in aqueous solution can be solubilized, for instance, by the addition of TBBA to a solution comprising water, sodium hydroxide (NaOH), and sodium dithionite (Na₂S₂O₄). The concentration of TBBA in solution (% by weight) may be in the range of 0.01% (W/W)-40% (W/W). More preferably, the concentration of TBBA may be in the range of 0.01% (W/W)-20% (W/W).

The method for preserving wood comprises impregnating the wood by pressure-treatment with TBBA or its homologues and derivatives

### DETAILED DESCRIPTION OF PREFERRED EMBODIMENTS

The above characteristics and advantages of the invention will be better understood through the following illustrative and non-limitative examples of preferred embodiments thereof.

### Example 1

### Biological Screening Test (Modified EN 113)

The following fungi were employed in this test: Coniophora puteana (Brown rot fungus) and Poria placenta (Brown rot fungus). The following preservative was tested: TBBA (in ethanol carrier). Five concentrations of the preservative were used: 2%, 1%, 0.1%, 0.05% and 0.01% (w/w).

All wood blocks employed in the examples to follow were of Scots pine sapwood (Pinus sylvestris) with a volume of 1 cm³ (10 mm×10 mm×10 mm). Five replicate test specimens were used for each concentration of the preservative. Six virulence control specimens for each fungus were used to establish the wood decay capability of the fungi. Other test blocks were used to establish: the virulence of the test fungi; the absence of a preserving effect of the ethanol carrier; and weight changes of test blocks for reasons other than decay
Treated test specimens: 2 (fungi)×5 (preservative concentrations)×1 (preservative)×5 (replicates)=50 test blocks
Untreated test specimens (for exposure alongside treated blocks): one for each treated block=50 test blocks
Virulence control specimens: 2 (fungi)×6 (replicates)=12 test blocks
Ethanol carrier test specimens: 2 (fungi)×5 (replicates)=10 test blocks
Treated check test specimens: 1 (preservatives)×5 (concentrations)×5 (replicates)=25

All timber specimens, where applicable, were treated with preservative (vacuum impregnation) and sterilized (ionizing radiation) prior to test, in accordance with European Standard EN 113. The incubation period for the test (length of block exposure to the chosen basidiomycete fungi) was 48 days or just under 7 weeks.

It was noted in this modified test that waterlogging (above 180% moisture content) of certain of the test specimens had occurred, probably due to the small size of the test specimens. Weight changes for particular waterlogged specimens, when these are clearly unrepresentative of a group, are not included in the mean figures presented.

Tables I and II show weight losses (% of initial dry weight) of TBBA treated and untreated control test specimens after 7 weeks exposure to Coniophora puteana and Poria placenta respectively.

In the tables, “retention” refers to the quantity of preservative that enters the wood per cubic meter of treated wood. It's value is determined by weighing the block of wood before and after it is treated with preservative, taking the difference between the two weights, and dividing the difference in weight by the volume of the block.

TABLE I
TBBA

| Concentrations | | | | |
|---|---|---|---|---|
| of | | | | |
| compositions | | | Corrected | Mean loss in |
| studied | | Retention | mean loss in | mass of |
| (% by weight) | Preservative | (kg/m³) | mass (%) | controls (%) |
| 2 | TBBA | 14.1 (0.63) (5) | No mass loss | 33.92 (10.20) |
| | | | | (5) |
| 1 | TBBA | 6.7 (0.46) (5) | 2.39 (1.56) (5) | 31.43 (2.02) (5) |
| 0.1 | TBBA | 0.7 (0.02) (5) | 24.80 (—) (1) | 26.37 (20.04) |
| | | | | (3) |
| 0.05 | TBBA | 0.4 (0.01) (5) | 40.63 (7.59) (5) | 29.94 (1.23) (5) |
| 0.01 | TBBA | 0.1 (0.00) (5) | 39.71(2.2) (4) | 32.35(7.60) (3) |

Note:
All untreated control blocks were exposed alongside treated blocks.
Standard deviations and number of specimens selected for each mean are presented in parenthesis.

TABLE II
TBBA

| Concentrations | | | | |
|---|---|---|---|---|
| of compositions | | | Corrected | Mean loss in |
| studied | | Retention | mean loss in | mass of |
| (% by weight) | Preservative | (kg/m³) | mass (%) | controls (%) |
| 2 | TBBA | 14.2 (0.48) (5) | 0.45 (1.48) (5) | 1.01 (3.04) (5) |
| 1 | TBBA | 6.9 (0.17) (5) | No mass loss | No mass loss |
| 0.1 | TBBA | 0.7 (0.05) (5) | 26.67(11.04) | 37.89 (7.52) (2) |
| | | | (3) | |
| 0.05 | TBBA | 0.4 (0.02) (5) | 4.84 (0.32) (5) | 11.03 (—) (1) |
| 0.01 | TBBA | 0.1 (0.00) (5) | 0.88 (0.29) (5) | No mass loss |

Note:
All untreated control blocks were exposed alongside treated blocks.
Standard deviations and number of specimens selected for each mean are presented in parenthesis.

Tables III and IV show weight losses (% of initial dry weight) of untreated virulence control specimens after 7 weeks exposure to Coniophora puteana and Poria placenta respectively.

TABLE III

| | | |
|---|---|---|
| | Loss in mass of | |
| Specimen Numbers | Virulence controls (%) | Mean loss in mass (%) |

| | | |
|---|---|---|
| 301 | 28.88 | 22.52 (7.38) |
| 302 | 30.59 | |
| 303 | 17.33 | |
| 304 | 13.56 | |
| 305 | 30.89 | |
| 306 | 21.95 | |

Note:
Standard deviation in parenthesis.

TABLE IV

| | Loss in mass of | |
|---|---|---|
| Specimen Numbers | Virulence controls (%) | Mean loss in mass (%) |
| 307 | No mass loss | Not calculated |
| 308 | 10.22 | |
| 309 | No mass loss | |
| 310 | No mass loss | |
| 311 | No mass loss | |
| 312 | No mass loss | |

Tables V and VI show weight losses (% of initial dry weight) of ethanol carrier control specimens after 7 weeks exposure to Coniophora puteana and Poria placenta respectively.

TABLE V
TBBA

| | Loss in mass of | |
|---|---|---|
| Specimen Numbers | Ethanol controls (%) | Mean loss in mass (%) |
| 319 | 1.19 | 26.09 (9.00) (4) |
| 320 | 13.67 | |
| 321 | 34.76 | |
| 322 | 26.14 | |
| 323 | 29.80 | |

Note:
Standard deviation and number of specimens selected for the mean presented in parenthesis.

TABLE VI
TBBA

| | Loss in mass of | |
|---|---|---|
| Specimen Numbers | Ethanol controls (%) | Mean loss in mass (%) |
| 324 | No mass loss | No mass loss |
| 325 | No mass loss | |
| 326 | No mass loss | |
| 327 | No mass loss | |
| 328 | No mass loss | |

The decay basidiomycete Coniophora puteana displayed a high degree of virulence during the test period (Table III) and was not affected by the ethanol carrier (Table V). The results shown in Table I, indicate that only specimens treated to the highest mean retention of 14.1 kg/m³ with TBBA displayed no weight loss. The mean weight loss of 2.39% recorded for specimens treated to a retention 6.7 kg/m³ with TBBA includes a figure of 4.77. The effect of waterlogging was minimal in this section of the test.

For Poria placenta the effect of waterlogging served to prevent the recording of any useful data from the virulence and carrier control tests (Tables IV and VI). The absence of decay in these tests is normally used to ascertain the validity of the remaining test results (shown in Table II). However, significant mean weight losses were recorded for several untreated and TBBA treated specimens (Table II) confirming that the absence of data from the virulence and carrier control tests was most likely due to waterlogging. The results shown in Table II indicate that specimens treated to mean TBBA retentions of 6.9 and 14.2 kg/m³ displayed no weight loss while specimens treated to 0.7 kg/m³ displayed a mean weight loss of 26.67%. Though waterlogging influenced the results of this test to some extent, the absence of waterlogging in TBBA treated specimens at the two highest retentions and the mass loss shown by waterlogged treated specimens at 0.7 kg/m³ gives confidence in the results (Table II).

### Example 2

### Penetration of TBBA into Timber Via Impregnation

An aqueous TBBA solution of 20.16% (w/w) was prepared by dissolving 217.5 g TBBA in 800 g H₂O, containing 33.6 g NaOH and 4 g Na₂S₂O₄.

The solution was stirred for 10 min at 45° C. Sample specimens consisting of 6 oven-dried sapwood blocks of Scots pine (Pinus sylvestris) measuring 20×20×20 mm were vacuum impregnated with the solution according to the methodology of the European standard EN 113. TBBA uptake into the blocks is shown in Table VII. Two further blocks of identical dimensions were vacuum impregnated with de-ionized water to serve as controls.

TABLE VII
TBBA

| Block No. | Block Dry Wt. (g) | Uptake Wt. (g) | TBBA Uptake (mg) |
|---|---|---|---|
| 1 | 3.19 | 8.64 | 1,100 |
| 2 | 4.12 | 10.62 | 1,311 |
| 3 | 3.82 | 9.36 | 1,115 |
| 4 | 3.38 | 8.90 | 1,113 |
| 5 | 3.28 | 9.22 | 1,197 |
| 6 | 3.05 | 9.84 | 1,369 |

The treated blocks were rapidly air-dried in the laboratory. Sawdust samples were recovered for TBBA extraction by hand-sanding the 6 faces of each of the 6 treated blocks for 30 seconds removing timber to an approximate depth of 0.75 mm on each occasion. This procedure was undertaken 4 times. New laboratory gloves and sandpaper were used for each sanding to negate contamination between the samples. This procedure provided 4 sawdust samples, as follows:
Sample 1: Representing 0-0.75 mm depth
Sample 2: Representing 0.75-1.5 mm depth
Sample 3: Representing 1.5-2.25 mm depth
Sample 4: Representing 2.25-3 mm depth.

The total volume of these samples equates to 65.7% of the total volume of the test blocks. A similar procedure was undertaken for the control blocks, but for these blocks, a surface sample (0-0.75 mm) only was removed.

Each sawdust sample was placed in a conical flask (125 cm³). De-ionized water (20 cm³) was added to each flask. The flasks were heated at 65° C. for precisely 1 hour. The contents of each flask were filtered (Whatman No. 1) into beakers and the filtered sawdust samples were discarded. The filtered solutions were brought to a pH of 5-6 using dilute hydrochloric acid added drop-wise (checked with pH paper). The contents of each beaker were thoroughly mixed throughout this addition procedure. A heavy precipitate was noted in the base of all the beakers except that containing the control blocks extracts (this last was discarded). The beakers were covered and left to stand. After 16 hours the supernatant was drained off from the 4 beakers containing precipitate and the remaining precipitate dried in an oven at 40° C. The dried precipitates were then dissolved in acetonitrile (20 cm³) and the solutions were filtered to remove any remaining undissolved precipitate. This procedure provided 4 clear solutions for High-Performance Liquid Chromatography (HPLC) analysis.

### Example 3

### Biological Efficacy Test (EN 113)

Two fungi were used: Coniophora puteana Brown rot fungus) and Poria placenta (Brown rot fungus). The preservative used was TBBA (waterborne). Seven concentrations of the preservative was used: 3.0%, 2.0%, 1.5%, 1.0%, 0.5%, 0.05%, and 0.0% (w/w), i.e. the carrier solution in the absence of the active material. All wood blocks were of Scots pine sapwood (Pinus sylvestris) with an approximate volume of 18.75 cm³ (50 mm×25 mm×15 mm) in accordance with European standard EN 113.
Treated test specimens: 2 (fungi)×7 (preservative concentrations)×1 (preservative)×4 (replicates)=56 test blocks
Untreated test specimens (for exposure alongside treated blocks): 2 (fungi)×7 (preservative concentrations)×1 (preservative)×4 (replicates)=56 test blocks
Untreated test specimens (virulence): 2 (fungi)×6 (replicates)=12 test blocks
Treated check test specimens: 4 (replicates)×7 (preservative concentrations)×1 (preservative)=28 test blocks

After block impregnation, according to European standard EN 113, and conditioning were completed, all the blocks were sterilized using ionizing radiation according to the conditions set out in EN 113. The incubation period for the test (length of block exposure to the chosen basidiomycete fungi) was 16 weeks.

It was noted that some waterlogging of certain test and control specimens had occurred. In keeping with the EN 113 format, weight changes for particular waterlogged specimens, when these are clearly unrepresentative of a group, were not included in the mean figures presented. In addition, weight losses of unrepresentative specimens generally, were not included in the mean figures presented.

Table VIII shows weight losses (% of initial dry weight) of TBBA treated, untreated control and virulence control test specimens after 16 weeks exposure to Coniophora puteana on an agar medium (EN 113).

TABLE VIII
TBBA

| Concen- | | | | |
|---|---|---|---|---|
| trations | | | | |
| of | | | | |
| compo- | | | | |
| sitions | | | | |
| studied | | | Corrected | Mean loss in |
| (% by | Retention | Specimen | mean loss in | mass of |
| weight) | (kg/m³) | Numbers | mass (%) | controls (%) |
| 3.0 | 23.65 (1.43) | 1-4 | −1.06 (0.69) | 48.61 (4.37) |
| 2.0 | 15.24 (1.56) | 13-16 | −6.79 (0.34) | 54.72 (8.50) |
| 1.5 | 11.12 (0.79) | 25-28 | −1.30 (1.16) | 63.51 (1.00) |
| 1.0 | 7.30 (0.26) | 37-40 | 37.27 (—) | 57.35 (5.75) |
| 0.5 | 3.78 (0.10) | 49-52 | 34.87 (13.21) | 46.93 (8.84) |
| 0.05 | 0.39 (0.01) | 61-64 | 46.82 (6.31) | 47.78 (11.83) |
| 0.0 | 0.00 | 73-76 | 41.94 (7.62) | 45.28 (5.83) |

| | |
|---|---|
| Mean loss in mass (%) of virulence control specimens: | 48.34 (6.48) |

Note:
All untreated control blocks were exposed alongside treated blocks. Standard deviations for each mean are presented in parenthesis.
Means have been adjusted for outlying values.

Table IX shows weight losses (% of initial dry weight) of TBBA treated, untreated control and virulence control test specimens after 16 weeks exposure to Poria placenta on an agar medium (EN 113).

TABLE IX
TBBA

| Concentrations | | | | |
|---|---|---|---|---|
| of | | | | |
| compositions | | | | Mean loss in |
| studied | Retention | | Corrected mean | mass of controls |
| (% by weight) | (kg/m³) | Specimen Numbers | loss in mass (%) | (%) |
| 3.0 | 20.70 (5.39) | 5-8 | −1.67 (0.22) | 29.36 (—) |
| 2.0 | 12.84 (4.60) | 17-20 | −6.21 (0.44) | 46.17 (—) |
| 1.5 | 11.81 (0.47) | 29-32 | −2.19 (070) | 47.29 (6.19) |
| 1.0 | 7.71 (0.19) | 41-44 | 6.17 (14.50) | 43.54 (2.19) |
| 0.5 | 3.79 (0.15) | 53-56 | 7.94 (19.35) | 32.95 (12.47) |
| 0.05 | 0.25 (0.28) | 65-68 | 30.94 (2.90) | 30.85 (5.62) |
| 0.0 | 0.00 | 77-80 | 30.23 (4.37) | 32.41 (4.16) |

| | |
|---|---|
| Mean loss in mass (%) of virulence control specimens: | 29.19 (14.28) |

Note:
All untreated control blocks were exposed alongside treated blocks.
Standard deviations for each mean are presented in parenthesis.
Means have been adjusted for outlying values.

The decay basidiomycete Coniophora puteana displayed a high degree of virulence against untreated virulence control specimens resulting in a mean weight loss of 48.3% (Table VIII). These weight losses were well in excess of the minimum 20% weight loss required to validate the test for this organism. In addition, the mean loss in mass of control specimens (incubated alongside treated specimens) was consistently high indicating good decay conditions within each culture vessel.

Coniophora puteana+TBBA: Table VIII shows that specimens treated with TBBA to retentions of 11.12 kg/m³ and upwards displayed no weight loss. These retentions therefore afforded satisfactory protection to the timber under the conditions of this test. Specimens treated with TBBA to retentions of 7.30 kg/m³ and below did not afford satisfactory protection to the timber samples. The toxic values of TBBA with respect to Coniophora puteana therefore lie between 7.30 and 11.12 kg/m³.

The decay basidiomycete Poria placenta displayed a high degree of virulence against untreated virulence control specimens resulting in a mean weight loss of 29.2% (Table IX).

Poria placenta+TBBA: Table IX shows that specimens treated with TBBA to retentions of 11.81 kg/m³ and upwards display no weight loss.

These retentions therefore afford satisfactory protection to the timber under the conditions of this test. Specimens treated with TBBA to retentions of 7.71 kg/m³ and below do not afford satisfactory protection to the timber samples. The toxic values of TBBA with respect to Poria placenta therefore lie between 7.71 and 11.81 kg/m3.

### Example 4

### Biological Efficacy Test (ASTM D1413-76)

The following fungi were tested: Neo-Lentinus lepideus (Brown rot fungus), Poria placenta (Brown rot fungus) and Gloeophyllum trabeum (Brown rot fungus). The preservative used was TBBA (waterborne). Seven concentrations of the preservative was used: 3.0%, 2.0%, 1.5%, 1.0%, 0.5%, 0.05% and 0.0% (w/w), i.e. the carrier solution in the absence of the preservative. All wood blocks were of Scots pine sapwood (Pinus sylvestris) with an approximate volume of 6.86 cm³ (19 mm×19 mm×19 mm). All wood block specimens, where applicable, were vacuum impregnated with the preservative concentrations according to American standard ASTM D1413-76.
Treated test specimens: 3 (fungi)×7 (preservative concentrations)×1 (preservative)×8 (replicates)=168 test blocks
Untreated test specimens (control): 3 (fungi)×1 (preservative)×4 (replicates)=12 test blocks

After block treatments were completed, all the blocks were sterilized using ionizing radiation according to the conditions set out in American standard ASTM D1413-76. The incubation period for the test was 12 weeks.

Table X shows weight losses (% of initial conditioned dry weight) of TBBA treated and control specimens after 12 weeks exposure to Neo-Lentinus lepideus on a soil block medium (ASTM D1413-76).

TABLE X
TBBA

| Concentrations | | | | |
|---|---|---|---|---|
| of compositions | | | | Mean loss in |
| studied | Retention | | Corrected mean | mass of controls |
| (% by weight) | (kg/m³) | Specimen Numbers | loss in mass (%) | (%) |
| 3.0 | 23.79 (0.72) | 1-8 | 0.11 (0.38) | 29.75 (6.76) |
| 2.0 | 15.51 (0.35) | 25-32 | 0.04 (0.20) | |
| 1.5 | 11.61 (0.53) | 49-56 | 0.04 (0.09) | |
| 1.0 | 7.62 (0.19) | 73-80 | 0.36 (0.19) | |
| 0.5 | 3.86 (0.12) | 97-104 | 4.55 (16.26) | |
| 0.05 | 0.40 (0.01) | 121-128 | 31.44 (5.65) | |
| 0.0 | 0.00 | 145-152 | 22.67 (8.84) | |

Note:
Standard deviations for each mean are presented in parenthesis.

Table XI shows weight losses (% of initial conditioned dry weight) of TBBA treated and control test specimens after 12 weeks exposure to Poria placenta on a soil block medium (ASTM D1413-76).

TABLE XI
TBBA

| Concentrations of | | | | |
|---|---|---|---|---|
| compositions | | | | Mean loss |
| studied | Retention | Specimen | Corrected mean | in mass of controls |
| (% by weight) | (kg/m³) | Numbers | loss in mass (%) | (%) |
| 3.0 | 23.22 (0.85) | 9-16 | −0.71 (0.14) | 27.06 (7.51) |
| 2.0 | 15.72 (0.47) | 33-40 | −0.29 (0.26) | |
| 1.5 | 11.57 (0.40) | 57-64 | −0.12 (0.28) | |
| 1.0 | 7.81 (0.26) | 81-88 | 9.65 (18.03) | |
| 0.5 | 3.86 (0.05) | 105-112 | 30.27 (5.59) | |
| 0.05 | 0.38 (0.01) | 129-136 | 31.70 (9.88) | |
| 0.0 | 0.00 | 153-160 | 23.48 (5.07) | |

Note:
Standard deviations for each mean are presented in parenthesis.

Table XII shows weight losses (% of initial conditioned dry weight) of TBBA treated and control test specimens after 12 weeks exposure to Gloeophyllum trabeum on a soil block medium (ASTM D1413-76).

TABLE XII
TBBA

| Concentrations of | | | | |
|---|---|---|---|---|
| compositions | | | Corrected | |
| studied | Retention | Specimen | mean loss in mass | Mean loss in mass |
| (% by weight) | (kg/m³) | Numbers | (%) | of controls (%) |
| 3.0 | 23.02 (0.85) | 17-24 | 0.13 (0.26) | 41.06 (12.74) |
| 2.0 | 15.62 (0.33) | 41-48 | 0.29 (0.25) | |
| 1.5 | 11.75 (0.26) | 65-72 | 2.232 (4.66) | |
| 1.0 | 7.73 (0.17) | 89-96 | 5.52 (8.99) | |
| 0.5 | 3.87 (0.15) | 113-120 | 45.02 (7.20) | |
| 0.05 | 0.38 (0.14) | 137-144 | 42.71 (13.14) | |
| 0.0 | 0.00 | 161-168 | 45.11 (14.46) | |

Note:
Standard deviations for each mean are presented in parenthesis.

The decay basidiomycete Neo-Lentinus lepideus displayed a high degree of virulence against untreated control specimens resulting in a mean weight loss of 29.7% (Table X).

Neo-Lentinus lepideus+TBBA: Table X shows that specimens treated with TBBA to retentions of 7.62 kg/m³ and upwards displayed no significant weight loss. These retentions therefore afforded satisfactory protection to the timber under the conditions of this test. Specimens treated with TBBA to retentions of 3.86 kg/m³ and below were not protected. The threshold retention of TBBA in respect of Neo-Lentinus lepideus therefore lies between 3.86 and 7.62 kg/m³.

Poria placenta+TBBA: The decay basidiomycete Poria placenta displayed a high degree of virulence against untreated control specimens resulting in a mean weight loss of 27.0% (Table XI).

Table XI shows that specimens treated with TBBA to retentions of 11.57 kg/m³ and upwards displayed no weight loss. These retentions therefore afforded satisfactory protection to the timber under the conditions of this test. Specimens treated with TBBA to retentions of up to 7.81 kg/m³ did not afford satisfactory protection to the timber samples. The threshold retention of TBBA in respect of Poria placenta therefore lies between 7.81 and 11.57 kg/m³.

Gloeophyllum trabeum+TBBA: The decay basidiomycete Gloeophyllum trabeum displayed a high degree of virulence against untreated control specimens resulting in a mean weight loss of 41.0% (Table XII).

Table XII shows that specimens treated with TBBA to retentions of 15.62 kg/m³ and upwards displayed no significant weight loss. These retentions therefore afforded satisfactory protection to the timber under the conditions of this test. Specimens treated with TBBA to retentions of up to 11.75 kg/m³ did not afford satisfactory protection to the timber samples. The threshold retention of TBBA in respect of Gloeophyllum trabeum therefore lies between 11.75 and 15.62 kg/m³.

### Example 5

### Biological Screening Test (Modified EN 113)

The following fungi were employed: Coniophora puteana (Brown rot fungus) and Poria placenta (Brown rot fungus). The following preservatives were tested: TBBF (waterborne), TBBE (waterborne), TBBZ (waterborne) and TBBS (waterborne).

Five concentrations of each preservative were tested: 3.0%, 2.0%, 1.0%, 0.1% and 0.05% (w/w). All wood blocks were of Scots pine sapwood (Pinus sylvestris) with a volume of 1 cm³ (10 mm×10 mm×10 mm). Five replicates were used for each test specimen type and six virulence control specimens for each fungus and for each preservative were used as follows:
Treated test specimens: 2 (fungi)×5 (preservative concentrations)×1 (preservative)×5 (replicates)=50 test blocks
Untreated test specimens (for exposure alongside untreated test blocks): 2 (fungi)×5 (preservative concentrations)×1 (preservative)×5 (replicates)=50 test blocks
Treated check test specimens: 1 (preservative)×5 (concentrations)×5 (replicates)=25 blocks

For all actives/preservatives in the test:
Virulence control specimens: 2 (fungi)×6 (replicates)=12 test blocks

After block treatments were completed, all the blocks were sterilized using ionizing radiation according to the conditions set out in European standard EN 113. The incubation period for the test (length of block exposure to the chosen basidiomycete fungi) was 8 weeks.

It was noted in this modified test that waterlogging (180% moisture content and above) of a number of the test specimens had occurred. Weight changes for particular waterlogged specimens, when these were clearly unrepresentative of a group, were not included in the mean figures presented. In addition, weight losses of unrepresentative specimens generally, were not included in the mean figures presented (note that “unrepresentative”, in this context, does not refer to very high weight loss figures, as these cannot be discarded).

Tables XIII and XIV show weight losses (% of initial dry weight) of TBBF treated test specimens after 8 weeks exposure to Coniophora puteana and Poria placenta respectively.

TABLE XIII
TBBF

| Concentrations of | | | |
|---|---|---|---|
| compositions | | | |
| studied | Retention | Corrected mean | Mean loss in mass |
| (% by weight) | (kg/m³) | loss in mass (%) | of controls (%) |
| 3.0 | 23.1 (2.07) | No Decay | 30.51 (7.04) |
| 2.0 | 15.1 (1.35) | No Decay | 12.06 (11.49) |
| 1.0 | 7.9 (0.36) | No Decay | 37.00 (6.13) |
| 0.1 | 0.8 (0.02) | 24.49 (2.12) (W) | 30.82 (1.73) |
| 0.05 | 0.4 (0.02) | 26.87 (7.38) | 29.50 (4.21) |

Note:
Standard deviations are presented in parenthesis.
W: Some Waterlogging.

TABLE XIV
TBBF

| Concentrations of | | | |
|---|---|---|---|
| compositions | | Corrected | |
| studied | Retention | mean loss in | Mean loss in |
| (% by weight) | (kg/m³) | mass (%) | mass of controls (%) |
| 3.0 | 20.8 (4.27) | No Decay | No Decay |
| 2.0 | 15.7 (0.83) | No Decay | 49.54 (—) |
| 1.0 | 7.7 (0.59) | No Decay | 36.67 (14.24) |
| 0.1 | 0.8 (0.02) | 20.90 (0.23) | 25.25 (9.67) |
| 0.05 | 0.4 (0.11) | 24.20 (9.63) | 11.16 (23.82) |

Note:
Standard deviations are presented in parenthesis.

Tables XV and XVI show weight losses (% of initial dry weight) of TBBE treated test specimens after 8 weeks exposure to Coniophora puteana and Poria placenta respectively.

TABLE XV
TBBE

| Concentrations of | | | |
|---|---|---|---|
| compositions | | Corrected | |
| studied | Retention | mean loss in | Mean loss in |
| (% by weight) | (kg/m³) | mass (%) | mass of controls (%) |
| 3.0 | 24.7 (0.64) | No Decay | 29.79 (3.30) |
| 2.0 | 14.7 (1.56) | No Decay | 31.38 (1.18) |
| 1.0 | 7.9 (0.43) | No Decay | 31.88 (10.29) |
| 0.1 | 0.7 (0.26) | 26.57 (2.99) | 28.34 (6.43) |
| 0.05 | 0.4 (0.01) | 22.96 (4.81) | 25.92 (13.81) |

Note:
Standard deviations are presented in parenthesis.

TABLE XVI
TBBE

| Concentrations of | | | |
|---|---|---|---|
| compositions | | | |
| studied | Retention | Corrected mean | Mean loss in |
| (% by weight) | (kg/m³) | loss in mass (%) | mass of controls (%) |
| 3.0 | 24.6 (0.58) | No Decay | 4.14 (11.18) |
| 2.0 | 14.4 (2.16) | No Decay (W) | 20.04 (11.36) |
| 1.0 | 8.3 (0.33) | No Decay (W) | No Decay |
| 0.1 | 0.8 (0.01) | 28.67 (14.13) | 25.01 (18.64) |
| 0.05 | 0.4 (0.04) | No Decay (0.89) | 13.49 (11.02) |

Note:
Standard deviations are presented in parenthesis.
W: Some Waterlogging.

Tables XVII and XVIII show weight losses (% of initial dry weight) of TBBZ treated test specimens after 8 weeks exposure to Coniophora puteana and Poria placenta respectively.

TABLE XVII
TBBZ

| Concentrations of | | | |
|---|---|---|---|
| compositions | | | |
| studied | Retention | Corrected mean | Mean loss in |
| (% by weight) | (kg/m³) | loss in mass (%) | mass of controls (%) |
| 3.0 | 17.6 (2.54) | No Decay | 15.61 (14.09) |
| 2.0 | 11.8 (2.51) | No Decay | 21.55 (12.21) |
| 1.0 | 6.8 (0.64) | 14.30 (—) | 35.96 (6.39) |
| 0.1 | 0.7 (0.06) | 34.44 (2.42 | 26.64 (9.00) |
| 0.05 | 0.4 (0.02) | 33.57 (7.59) (W) | 29.72 (5.54) |

Note:
Standard deviations are presented in parenthesis.
W: Some Waterlogging.

TABLE XVIII
TBBZ

| Concentrations of | | | |
|---|---|---|---|
| compositions | | | |
| studied | Retention | Corrected mean | Mean loss in |
| (% by weight) | (kg/m³) | loss in mass (%) | mass of controls (%) |
| 3.0 | 18.6 (3.41) | No Decay | 5.14 (9.79) |
| 2.0 | 11.6 (1.45) | No Decay | 0.13 (1.35) |
| 1.0 | 5.9 (3.04) | No Decay | 12.74 (21.19) |
| 0.1 | 0.8 (0.05) | 33.47 (15.74) | 22.84 (15.25) |
| 0.05 | 0.4 (0.01) | 0.94 (3.19) (W) | 45.31 (13.20) |

Note:
Standard deviations are presented in parenthesis.
W: Some Waterlogging.

Tables XIX and XX show weight losses (% of initial dry weight) of TBBS treated test specimens after 8 weeks exposure to Coniophora puteana and Poria placenta respectively.

TABLE XIX
TBBS

| Concentrations of | | | |
|---|---|---|---|
| compositions | | Corrected | |
| studied | Retention | mean loss in | Mean loss in |
| (% by weight) | (kg/m³) | mass (%) | mass of controls (%) |
| 3.0 | 20.2 (6.54) | No Decay | 28.61 (3.46) |
| 2.0 | 16.1 (0.79) | No Decay | 32.20 (6.54) |
| 1.0 | 7.6 (0.83) | No Decay | 38.42 (2.63) |
| 0.1 | 0.8 (0.02) | 35.49 (4.92) | 34.61 (2.02) |
| 0.05 | 0.4 (0.04) | 35.02 (6.61) | 36.59 (4.41) |

Note:
Standard deviations are presented in parenthesis.

TABLE XX
TBBS

| Concentrations of | | | |
|---|---|---|---|
| compositions | | Corrected | |
| studied | Retention | mean loss in | Mean loss in |
| (% by weight) | (kg/m³) | mass (%) | mass of controls (%) |
| 3.0 | 25.0 (0.46) | No Decay | 34.45 (4.00) |
| 2.0 | 15.3 (1.48) | No Decay | 32.43 (17.48) |
| 1.0 | 7.9 (1.13) | No Decay | 11.75 (27.33) |
| 0.1 | 0.8 (0.10) | No Decay | 12.02 (24.51) |
| 0.05 | 0.4 (0.01) | No Decay | 2.13 (0.78) |

Note:
Standard deviations are presented in parenthesis.

Tables XXI and XXII show weight losses (% of initial dry weight) of untreated virulence control specimens after 8 weeks exposure to Coniophora puteana and Poria placenta respectively.

TABLE XXI

| Specimen | Loss in | Mean loss in |
|---|---|---|
| Number | mass (%) | mass (%) |
| 1226 | 25.91 | |
| 1227 | 27.95 | |
| 1228 | 34.74 | 32.40 (4.35) |
| 1229 | 34.02 | |
| 1230 | 36.18 | |
| 1231 | 35.61 | |

Note:
All untreated control blocks were exposed alongside treated blocks.
Standard deviations are presented in parenthesis.

TABLE XXII

| Specimen | Loss in | Mean loss in |
|---|---|---|
| Number | mass (%) | mass (%) |
| 1232 | No Decay | |
| 1233 | No Decay | |
| 1234 | No Decay | |
| 1235 | No Decay | |
| 1236 | No Decay | |
| 1237 | 8.30 | |

Note:
All untreated control blocks were exposed alongside treated blocks.
Standard deviations are presented in parenthesis.

The decay basidiomycete Coniophora puteana displayed a high degree of virulence during the test period (Table XXI). This is confirmed by the generally excellent weight losses for untreated control specimens throughout the test (Tables XIII-XIX).

Table XIII indicates that test specimens treated with TBBF to a retention of between 0.8 and 7.9 kg/m³ will provide a protective effect against Coniophora puteana (under the conditions of this test).

Table XV indicates that test specimens treated with TBBE to a retention of between 0.7 and 7.9 kg/m³ will provide a protective effect against Coniophora puteana (under the conditions of this test).

Table XVII indicates that test specimens treated with TBBZ to a retention between 0.7 and 6.8 kg/m³ will provide a protective effect against Coniophora puteana (under the conditions of this test).

Table XIX indicates that test specimens treated with TBBS to a retention between 0.8 and 7.6 kg/m³ will provide a protective effect against Coniophora puteana (under the conditions of this test).

Overall results for Coniophora puteana can be summarised as follows, where the protective effect is expressed in terms of the retention of the active ingredient in the wood followed in parenthesis by the concentration of the active ingredient in solution.
TBBF: Protective Effect=0.8-7.9 kg/m³ (=>0.1-1.0%)
TBBE: Protective Effect=0.7-7.9 kg/m³ (=>0.1-1.0%)
TBBZ: Protective Effect=0.7-6.8 kg/m³ (=>0.1-1.0%)
TBBS: Protective Effect=0.8-7.6 kg/m³ (=>0.1-1.0%)

The virulence control specimen results for the decay basidiomycete Poria placenta indicate that this basidiomycete displayed a low degree of virulence during the test period (Table XXII). However, the variability in weight losses due to this basidiomycete for untreated control specimens throughout the test (Tables XIV-XX) indicate that, though the organism failed to establish itself completely, where this occurred, weight losses were of an order that the virulence of the organism was not in doubt.

Table XIV indicates that test specimens treated with TBBF to a retention of between 0.8 and 7.7 kg/m³ will provide a protective effect against Poria placenta (under the conditions of this test).

Table XVI indicates that test specimens treated with TBBE to a retention of between 0.8 and 8.3 kg/m³ will provide a protective effect against Poria placenta (under the conditions of this test).

Table XVIII indicates that test specimens treated with TBBZ to a retention between 0.8 and 5.9 kg/m³ will provide a protective effect against Poria placenta (under the conditions of this test).

The results shown in Table XX do not allow a toxic threshold to be extablished for TBBS. However, based on findings for Coniophora puteana (see section 3.2) it is likely to lie somewhere between 0.8 and 7.9 kg/m³.

Overall results for Poria placenta can be summarised as follows:
TBBF: Protective Effect=0.8-7.7 kg/m³ (=>0.1-1.0%)
TBBE: Protective Effect=0.8-8.3 kg/m³ (=>0.1-1.0%)
TBBZ: Protective Effect=0.8-5.9 kg/m³ (=>0.1-1.0%)
TBBS: Protective Effect=0.8-7.9 kg/m³ (=>0.1-1.0%)

### Example 6

### Wood Decay Test (Modified AWPA E7-01)

The preservative value of TBBA in terms of preventing wood decay was examined by ground contact exposure of TBBA treated stakes at a test plot in Gainesville, Fla. The test detail was essentially based on the “STANDARD METHOD OF EVALUATING WOOD PRESERVATIVES BY FIELD TESTS WITH STAKES”, Standard E7-01, promulgated by the American Wood Preservers Association (AWPA).

All the test stakes were of southern pine sapwood and were vacuum impregnated with TBBA. The TBBA was dissolved in one of four solutions: ethanol, P9 type A oil, and in two micro-emulsions:
emulsion #1: TBBA 20.81%, Butyl Lactate 31.02%, NP-15 22.33% and water 25.83%
emulsion #2: TBBA 20.05%, Butyl Lactate 29.88%, NP-15 21.51% and water 28.55%

Each of the emulsions was diluted so that the corresponding concentration (w/v) of TBBA in all of the solutions was: 1.72%, 3.4%, 5.1%, 6.8% and 8.5%.

Two groups of control stakes were also installed in the test plot. One group was vacuum impregnated with pure ethanol. The second group was untreated.

The groups of stakes for each treatment were installed in the test plot, left for seven months, and evaluated according to the procedure set-out in AWPA Standard E7-01. The Standard assigns decay grades, based on an evaluation made at the location of the most extensive degradation of the cross section of the stake, defined as follows:
Grade No. 10: Sound, even though there is a suspicion of decay
Grade No. 9: Trace decay to 3% of cross section
Grade No. 8: Decay from 3 to 10% of cross section
Grade No. 7: Decay from 10 to 30% of cross section
Grade No. 6: Decay from 30 to 50% of cross section
Grade No. 4: Decay from 50 to 75% of cross section
Failure

Table XXIII lists the decay ratings for each group of 10 stakes. The concentration of the active ingredient (AI) TBBA for each group of stakes is listed in units of pounds per cubit foot (PCF.

As can be seen, the group treated with pure ethanol has only 5 instances of Grade No. 10, while the addition of TBBA improved the rating to a count of 8-10. With other treatments of TBBA solutions, the rating ranged from 9-10 counts.

TABLE XXIII
TBBA

| | | DECAY RATINGS | | | | | | |
|---|---|---|---|---|---|---|---|---|
| TREATMENT | PCF, AI | “10” | “9” | “8” | “7” | “6” | “4” | “0” |
| UNTREATED | 0.00 | 0 | 1 | 2 | 0 | 0 | 1 | 6 |
| CONTROLS | | | | | | | | |
| ETHANOL CONTROLS | 0.00 | 5 | 1 | 0 | 0 | 1 | 1 | 2 |
| TBBA in ETHANOL | 0.50 | 8 | 1 | 0 | 0 | 0 | 0 | 1 |
| TBBA in ETHANOL | 1.00 | 10 | 0 | 0 | 0 | 0 | 0 | 0 |
| TBBA in ETHANOL | 1.50 | 8 | 1 | 0 | 0 | 0 | 0 | 1 |
| TBBA in ETHANOL | 2.00 | 8 | 1 | 0 | 0 | 0 | 0 | 1 |
| TBBA in ETHANOL | 2.50 | 9 | 0 | 0 | 0 | 0 | 0 | 1 |
| TBBA EMULSION #1 | 0.50 | 10 | 0 | 0 | 0 | 0 | 0 | 0 |
| TBBA EMULSION #1 | 1.00 | 10 | 0 | 0 | 0 | 0 | 0 | 0 |
| TBBA EMULSION #1 | 1.50 | 9 | 0 | 0 | 0 | 0 | 0 | 1 |
| TBBA EMULSION #1 | 2.00 | 10 | 0 | 0 | 0 | 0 | 0 | 0 |
| TBBA EMULSION #1 | 2.50 | 10 | 0 | 0 | 0 | 0 | 0 | 0 |
| TBBA EMULSION #2 | 0.50 | 9 | 1 | 0 | 0 | 0 | 0 | 0 |
| TBBA EMULSION #2 | 1.00 | 10 | 0 | 0 | 0 | 0 | 0 | 0 |
| TBBA EMULSION #2 | 1.50 | 10 | 0 | 0 | 0 | 0 | 0 | 0 |
| TBBA EMULSION #2 | 2.00 | 10 | 0 | 0 | 0 | 0 | 0 | 0 |
| TBBA EMULSION #2 | 2.50 | 10 | 0 | 0 | 0 | 0 | 0 | 0 |
| TBBA in P9 TYPE A OIL | 0.25 | 9 | 1 | 0 | 0 | 0 | 0 | 0 |
| TBBA in P9 TYPE A OIL | 0.50 | 10 | 0 | 0 | 0 | 0 | 0 | 0 |
| TBBA in P9 TYPE A OIL | 0.75 | 10 | 0 | 0 | 0 | 0 | 0 | 0 |
| TBBA in P9 TYPE A OIL | 1.00 | 9 | 1 | 0 | 0 | 0 | 0 | 0 |
| TBBA in P9 TYPE A OIL | 1.25 | 9 | 1 | 0 | 0 | 0 | 0 | 0 |

While embodiments of the invention have been described by way of illustration, it will be understood that the invention can be carried out by persons skilled in the art with many modifications, variations and adaptations, without departing from its spirit or exceeding the scope of the claims.

1. Use of Tetrabromobisphenol A (TBBA) or a homologue or a derivative thereof, as an anti-fungal wood preservative active ingredient.

2. Use according to claim 1, wherein the homologues are selected from Tetrabromobisphenol E, Tetrabromobisphenol F, Tetrabromobisphenol Z and Tetrabromobisphenol S.

3. Use according to claim 1, wherein TBBA or a homologue of TBBA is substituted by a substituent other than bromine, either on one or both phenyl rings, or at the bridge.

4. Use according to claim 1, wherein TBBA or its homologue or derivative is solubilized in an organic or aqueous solvent.

5. Use according to claim 4, wherein the solvent is an organic solvent selected from alcohols, e.g. ethanol, hydrocarbons, toluene and ketones.

6. Use according to claim 4, wherein the solution comprises, in addition to water, sodium hydroxide (NaOH), and sodium dithionite (Na₂S₂O₄).

7. Use according to claim 1, wherein the TBBA or its homologue or derivative is provided in an emulsion.

8. Use according to claim 7, wherein the emulsion comprises, in addition to water, Butyl Lactate, and NP-15.

9. Use according to claim 6, wherein the concentration of TBBA, or an homologue or derivative thereof is up to 40% (W/W).

10. Use according to claim 9, wherein the concentration of TBBA, or an homologue or derivative thereof, is in the range of 0.01%-20% (W/W).

11. A fungicidal wood preservative composition comprising an active ingredient selected from Tetrabromobisphenol A (TBBA) and homologues and derivatives thereof.

12. A composition according to claim 11, wherein the homologues are selected from Tetrabromobisphenol E, Tetrabromobisphenol F, Tetrabromobisphenol Z and Tetrabromobisphenol S.

13. A composition according to claim 11, wherein TBBA or a homologue of TBBA is substituted by a substituent other than bromine, either on one or both phenyl rings, or at the bridge.

14. A composition according to claim 11, wherein TBBA or its homologue or derivative is solubilized in an organic or aqueous solvent.

15. A composition according to claim 14, wherein the solvent is an organic solvent selected from alcohols, e.g. ethanol, hydrocarbons, toluene and ketones.

16. A composition according to claim 14, wherein the solution comprises, in addition to water, sodium hydroxide (NaOH), and sodium dithionite (Na ₂S₂O₄).

17. A composition according to claim 11, wherein the TBBA or its homologue or derivative is provided in an emulsion.

18. A composition according to claim 17, wherein the emulsion comprises, in addition to water, Butyl Lactate, and NP-15.

19. A composition according to claims 16, wherein the concentration of TBBA, or an homologue or derivative thereof is up to 40% (W/W).

20. A composition according to claim 11, wherein the concentration of TBBA, or an homologue or derivative thereof, is in the range of 0.01%-20% (W/W).

21. A fungicidal wood preservative according to claim 11, comprising TBBA, or an homologue or derivative thereof, as the active ingredient.

22. A method for preserving wood, comprising impregnating wood with a solution comprising a compound selected from Tetrabromobisphenol A (TBBA) and homologues and derivatives thereof as an active ingredient.

23. A method for preserving wood, comprising impregnating wood with a composition selected from Tetrabromobisphenol A (TBBA) and homologues and derivatives thereof, wherein the wood has been pressure-treated.

24. A wood product, preserved by impregnation with a compound selected from Tetrabromobisphenol A (TBBA) and homologues and derivatives thereof.
